(19) United States
(12) Patent Application Publication
(10) Pub. No.: US 2026/0109269 A1
(43) Pub. Date: Apr. 23, 2026

(54) POWER CONTROL APPARATUS AND POWER CONTROL METHOD

(71) Applicant: ISUZU MOTORS LIMITED, Yokohama-shi (JP)

(72) Inventor: Haruya TANAKA, Fujisawa-shi (JP)

(21) Appl. No.: 19/353,654

(22) Filed: Oct. 9, 2025

(30) Foreign Application Priority Data
Oct. 21, 2024 (JP) 2024-185255

(51) Int. Cl. B60L 58/40; B60L 15/20; B60L 58/12

(52) U.S. Cl. CPC B60L 58/40; B60L 15/2081; B60L 58/12; B60L 2240/12; B60L 2240/14; B60L 2240/642; B60L 2240/68

(57) ABSTRACT

A power control apparatus includes: a receiving unit that receives traffic information indicating traffic conditions ahead of a vehicle; an acquisition unit that acquires a vehicle speed of the vehicle and a state of charge of a battery included in the vehicle; an estimation unit that estimates whether the vehicle will accelerate after a predetermined time period has elapsed on the basis of the traffic conditions when the vehicle speed is equal to or less than a first threshold value and the state of charge is less than a predetermined state of charge; and a power control unit that causes, as a result of the estimation unit having estimated that the vehicle will accelerate, a fuel cell included in the vehicle to output a predetermined electric power before the vehicle begins to accelerate.

### CROSS-REFERENCE TO RELATED APPLICATIONS

The present application claims priority to Japanese Patent Application number 2024-185255, filed on October 21, 2024, contents of which are incorporated herein by reference in its entirety.

### BACKGROUND OF THE INVENTION

The present disclosure relates to a power control apparatus and a power control method. A conventional fuel cell vehicle includes a fuel cell and a battery, and stores surplus electric power, which is a difference between electric power output from the fuel cell and electric power for driving the fuel cell vehicle, in the battery (for example, Japanese Unexamined Patent Application Publication No.2019-129551).

In the fuel cell vehicle, the greater the acceleration, the greater the amount of change in the electric power that the fuel cell outputs to the motor per unit time. Compared to other fuel cell vehicles without mounted equipment, a fuel cell vehicle equipped with mounted equipment is heavier, and therefore the amount of change during acceleration is greater. Therefore, in the fuel cell vehicle on which the mounted equipment is mounted, the amount of change in electric power is more likely to increase during acceleration, such as when traffic congestion clears, which results in the fuel cell being more prone to deterioration.

### BRIEF SUMMARY OF THE INVENTION

The present disclosure has been made in view of these points, and its object is to reduce the amount of change in electric power output from a fuel cell.

A power control apparatus according to a first aspect of the present disclosure includes: a receiving unit that receives traffic information indicating traffic conditions ahead of a vehicle; an acquisition unit that acquires a vehicle speed of the vehicle and a state of charge of a battery included in the vehicle; an estimation unit that estimates whether the vehicle will accelerate after a predetermined time period has elapsed on the basis of the traffic conditions in a case where the vehicle speed is equal to or less than a first threshold value and the state of charge is less than a predetermined state of charge; and a power control unit that causes, as a result of the estimation unit having estimated that the vehicle will accelerate, a fuel cell included in the vehicle to output a predetermined electric power before the vehicle begins to accelerate, wherein the power control unit causes the battery to be charged with surplus electric power obtained by subtracting, from the predetermined electric power, a first electric power required by mounted equipment included in the vehicle and a second electric power required by a drive source included in the vehicle.

A power control method according to a second aspect of the present disclosure, executed by a processor, and including the steps of: acquiring a vehicle speed of a vehicle and a state of charge of a battery included in the vehicle; receiving traffic information indicating traffic conditions ahead of the vehicle; estimating whether the vehicle will accelerate after a predetermined time period has elapsed on the basis of the traffic conditions in a case where the vehicle speed is equal to or less than a first threshold value and the state of charge is less than a predetermined state of charge; power-controlling, as a result of estimating in the estimating that the vehicle will accelerate, to cause a fuel cell included in the vehicle to output a predetermined electric power before the vehicle begins to accelerate, the power-controlling including causing the battery to be charged with surplus electric power obtained by subtracting, from the predetermined electric power, a first electric power required by mounted equipment included in the vehicle and a second electric power required by a drive source included in the vehicle.

### BRIEF DESCRIPTION OF THE DRAWINGS

FIG. 1 is a diagram illustrating an overview of a vehicle S according to the present embodiment.

FIG. 2 is a diagram illustrating an example of an operation of a power control apparatus 10.

FIG. 3 is a diagram illustrating an operation of a power control apparatus 10 when predetermined electric power is generated.

FIG. 4 is a diagram showing an example of an operation in which a fuel cell 5 outputs the predetermined electric power.

FIG. 5 is a diagram illustrating an example of a processing sequence in the power control apparatus 10.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### <Overview of a vehicle S>

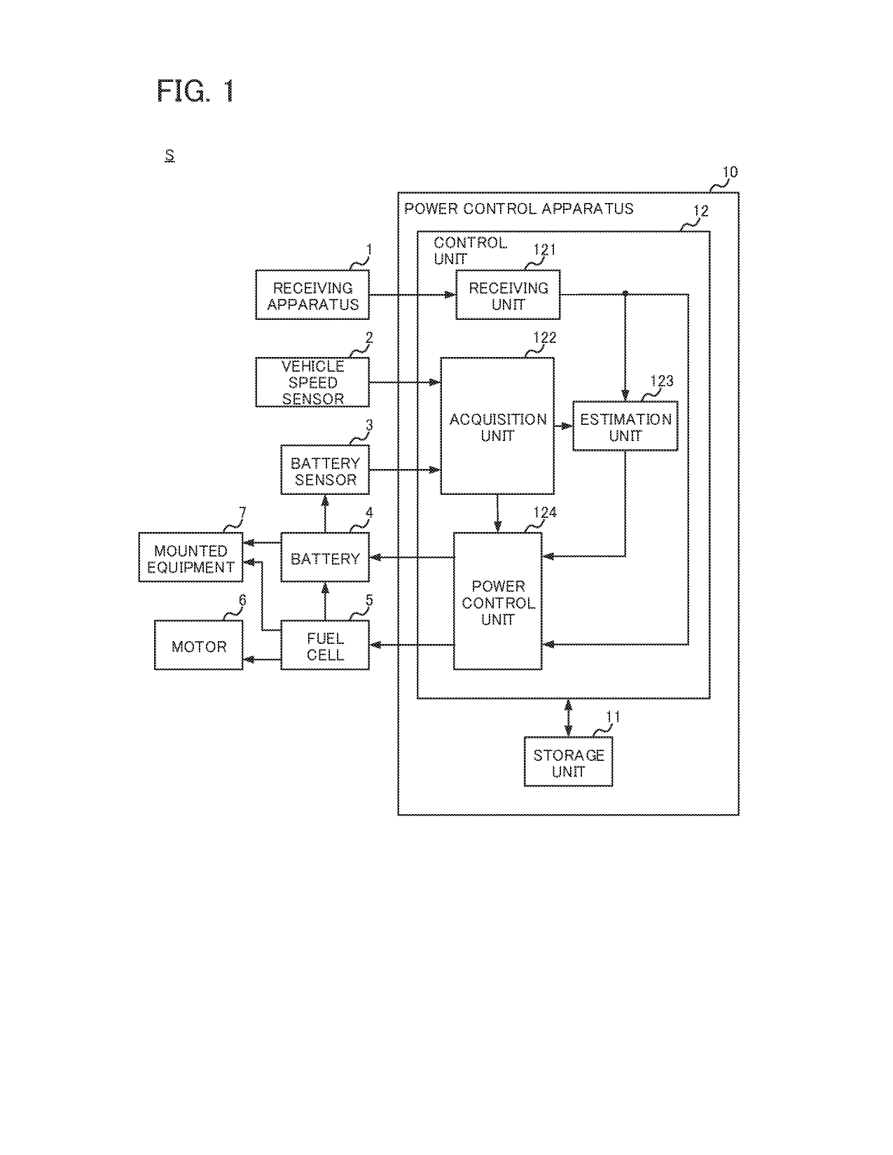

FIG. 1 is a diagram illustrating an overview of a vehicle S according to the present embodiment. The vehicle S illustrated in FIG. 1 includes a receiving apparatus 1, a vehicle speed sensor 2, a battery sensor 3, a battery 4, a fuel cell 5, a motor 6, mounted equipment 7, and a power control apparatus 10. The vehicle S is a vehicle that travels by having the motor 6 driven through the supply of electric power from the fuel cell 5, and is, for example, a fuel cell vehicle (FCV).

The receiving apparatus 1 is a receiver that receives, as traffic information, at least one of ITS (Intelligent Transport Systems) information, VICS (Vehicle Information and Communication System) (registered trademark) information, or probe traffic information from an external information processing apparatus. The traffic information includes, for example, gradient information indicating a gradient ahead of the vehicle S, other vehicle information indicating a speed of another vehicle ahead of the vehicle S, and section information indicating a construction section or a congestion section ahead of the vehicle S.

The vehicle speed sensor 2 is a sensor for detecting the vehicle speed of the vehicle S. The battery sensor 3 is a sensor for detecting a state of charge (SOC) of the battery 4. The battery 4 is an energy storage device having a secondary battery such as a lithium ion battery, and is a device that outputs electric power to the mounted equipment 7 and charges electric power generated by the fuel cell 5.

The fuel cell 5 is a cell that converts chemical energy into electrical energy by reacting fuel with an oxidizing agent. The fuel cell 5 converts chemical energy into electrical energy by, for example, generating water through a reaction between hydrogen stored in a hydrogen tank (not shown) of the vehicle S and oxygen contained in the atmosphere (air). The fuel cell 5 supplies the converted electric energy (electric power) to the motor 6 and the mounted equipment 7 and charges the battery 4.

The motor 6 is an electric motor for driving the vehicle S, and is a drive source driven by electric power supplied from the fuel cell 5. The mounted equipment 7 is a device that is provided on a bed of the vehicle S and operates using the electric power supplied from the battery 4 and the fuel cell 5, and is, for example, a freezer unit or a refrigerated unit.

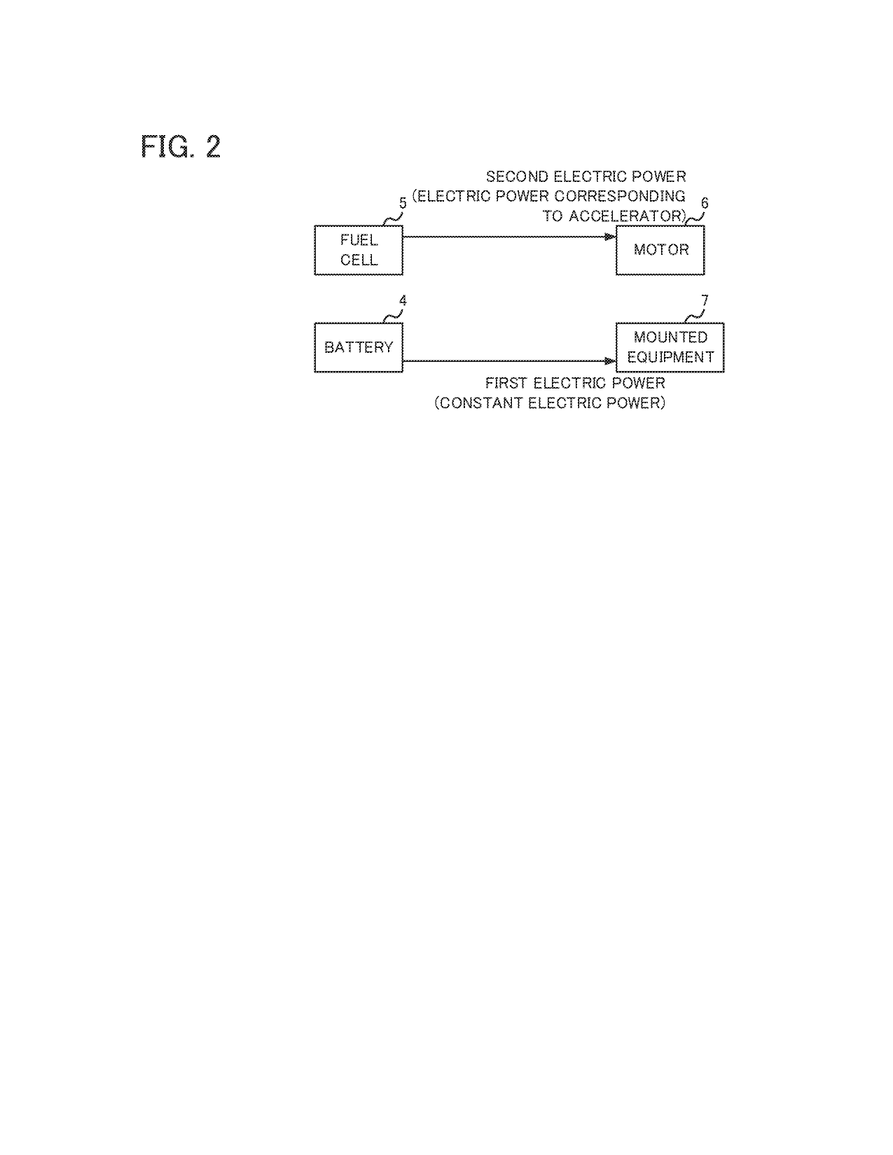

The power control apparatus 10 is a device for outputting the electric power from the battery 4 and the fuel cell 5. FIG. 2 is a diagram illustrating an example of the operation of the power control apparatus 10. As shown in FIG. 2, the power control apparatus 10 causes the battery 4 to output first electric power to the mounted equipment 7, and causes the fuel cell 5 to output second electric power to the motor 6. The first electric power is a constant amount of electric power required by the mounted equipment 7 included in the vehicle S. The second electric power is electric power required by the motor 6 included in the vehicle S, and corresponds to a depression amount of an accelerator pedal (not shown) included in the vehicle S.

In the vehicle S, as the acceleration of the vehicle S increases, the amount of change in the electric power that the fuel cell 5 outputs to the motor 6 per unit time increases. Since the vehicle S is heavier than other vehicles not equipped with the mounted equipment 7, the amount of change with respect to acceleration increases due to the inclusion of the mounted equipment 7. Therefore, in the vehicle S, for example, the amount of change is more likely to increase during acceleration when traffic congestion clears, making the fuel cell 5 more prone to deteriorate.

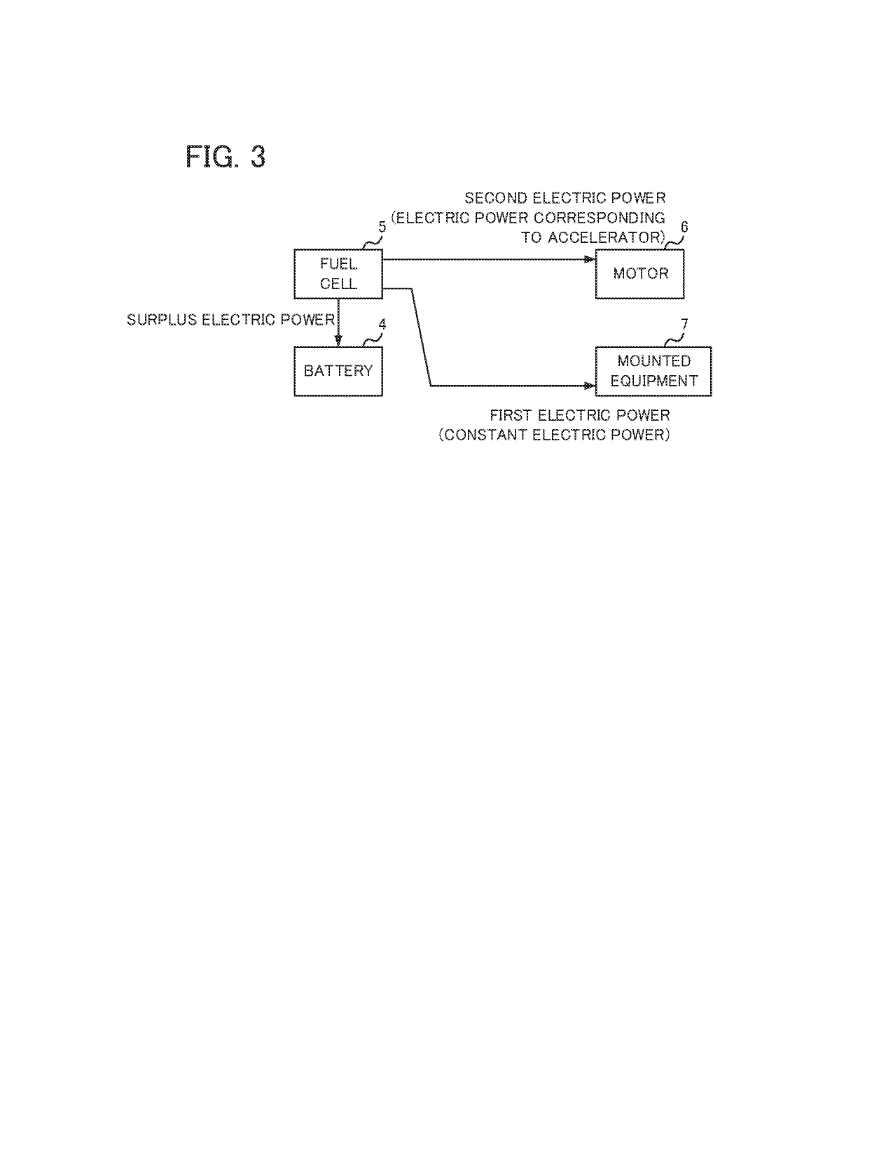

Therefore, the power control apparatus 10 estimates a timing at which traffic congestion clears on the basis of the traffic information received by the receiving apparatus 1, and causes the fuel cell 5 to generate predetermined electric power from a time prior to that timing. The predetermined electric power is, for example, electric power greater than the sum of the second electric power required for acceleration when traffic congestion clears and the first electric power required by the mounted equipment 7. FIG. 3 is a diagram illustrating the operation of the power control apparatus 10 when the predetermined electric power is generated. As shown in FIG. 3, the power control apparatus 10 causes the fuel cell 5, from the predetermined electric power, to output the first electric power to the mounted equipment 7 and the second electric power to the motor 6, and causes the battery 4 to be charged with surplus electric power obtained by subtracting the first electric power and the second electric power from the predetermined electric power.

By operating in this manner, the power control apparatus 10 can keep the electric power generated by the fuel cell 5 constant even if the amount of change in the second electric power increases when traffic congestion clears. Furthermore, the power control apparatus 10 can extend the time period required to raise the electric power generated by the fuel cell 5 to the predetermined electric power by causing the fuel cell 5 to generate the predetermined electric power from a time prior to the clearing of traffic congestion. As a result, since the power control apparatus 10 can reduce the amount of change per unit time in the electric power generated by the fuel cell 5, deterioration of the fuel cell 5 can be suppressed. Hereinafter, the configuration and operation of the power control apparatus 10 will be described in detail.

### <Configuration of the power control unit 10>

As illustrated in FIG. 1, the power control apparatus 10 includes a storage unit 11 and a control unit 12. The control unit 12 includes a receiving unit 121, an acquisition unit 122, an estimation unit 123, and a power control unit 124.

The storage unit 11 includes, for example, a storage medium such as a ROM (Read Only Memory), a RAM (Random Access Memory), a hard disk drive (HDD), or a solid state drive (SSD). The storage unit 11 stores programs executed by the control unit 12 and various types of information for outputting electric power from the battery 4 and the fuel cell 5.

The control unit 12 is a processor such as a CPU (Central Processing Unit). The control unit 12 functions as the receiving unit 121, the acquisition unit 122, the estimation unit 123, and the power control unit 124 by executing the programs stored in the storage unit 11. The control unit 12 may be configured by a single processor, or may be configured by a plurality of processors or a combination of one or more processors and an electronic circuit.

The receiving unit 121 receives traffic information indicating traffic conditions ahead of the vehicle S. The traffic information includes, for example, gradient information, other vehicle information, section information, and road information. The gradient information is information indicating a type of a gradient (an upward gradient or a downward gradient) ahead of the vehicle S. The other vehicle information is information indicating the speed and position of one or more other vehicles ahead of the vehicle S. The section information is information indicating the position of a construction section or a congestion section ahead of the vehicle S. The road information is information indicating a type of the road (a general road or an expressway) on which the vehicle S is traveling, and the position of the vehicle S. The receiving unit 121 receives the traffic information from the receiving apparatus 1 by, for example, acquiring, as the traffic information, at least one of ITS information, VICS information, or probe traffic information.

The acquisition unit 122 acquires the vehicle speed of the vehicle S and the state of charge of the battery 4 included in the vehicle S. The acquisition unit 122 acquires, for example, the vehicle speed of the vehicle S detected by the vehicle speed sensor 2 and the state of charge of the battery 4 detected by the battery sensor 3.

The estimation unit 123 estimates whether the vehicle S will accelerate when traffic congestion on the road on which the vehicle S travels clears, in a state in which the battery 4 can be charged. When the vehicle speed is equal to or less than a first threshold value and the state of charge is less than a predetermined state of charge, the estimation unit 123 estimates, on the basis of the traffic conditions, whether the vehicle S will accelerate after a predetermined time period has elapsed. The first threshold value is the maximum value of the speed of the vehicle S during traffic congestion, determined by the estimation unit 123 on the basis of the gradient ahead of the vehicle S, and is, for example, a value equal to or greater than 14 km per hour and less than 22 km per hour. For example, the estimation unit 123 reduces the first threshold value when the type of gradient included in the gradient information is an upward gradient, compared to when the type of gradient is a downward gradient. The predetermined state of charge is the maximum value of the state of charge at which the battery 4 can be charged, and is, for example, a fixed value indicating 80% or more.

The predetermined time period is an estimated time period determined by the estimation unit 123 on the basis of the vehicle speed of the vehicle S and the type of the road on which the vehicle S is traveling. For example, the estimation unit 123 reduces the predetermined time period as the vehicle speed acquired by the acquisition unit 122 increases. For example, when the road on which the vehicle S is traveling, included in the road information received by the receiving unit 121, is a general road, the estimation unit 123 reduces the predetermined time period, compared to when the road is an expressway. By operating in this manner, the estimation unit 123 can extend the predetermined time period on expressways, where traffic volume per unit time is less likely to change compared to general roads, thereby reducing the amount of change in electric power when raising the electric power generated by the fuel cell 5 to the predetermined power.

For example, the estimation unit 123 estimates whether the vehicle S will accelerate on the basis of the vehicle speed of another vehicle. For example, when the speed of another vehicle ahead of the vehicle S, included in the other vehicle information received by the receiving unit 121, is equal to or greater than the first threshold value, the estimation unit 123 identifies the distance between the position of the other vehicle included in the other vehicle information and the position of the vehicle S included in the road information. The estimation unit 123 calculates the time to arrival for the vehicle S to reach the position of the other vehicle on the basis of the vehicle speed of the vehicle S and the identified distance, estimates that the vehicle S will accelerate when the time to arrival is equal to or greater than the predetermined time period, and estimates that the vehicle S will not accelerate when the time to arrival is less than the predetermined time period.

That is, the estimation unit 123 estimates that the vehicle S will accelerate when the time to arrival, based on the distance between the position of another vehicle and the position of the vehicle S and the vehicle speed of the vehicle S, for the vehicle S to reach the position of the other vehicle is equal to or greater than the predetermined time period. On the other hand, when the time to arrival is less than the predetermined time period, the estimation unit 123 estimates that the vehicle S will not accelerate.

The estimation unit 123 may estimate whether the vehicle S will accelerate on the basis of a distance between the end position of the construction section or the congestion section on the vehicle S side and the position of the vehicle S, and the vehicle speed. For example, the estimation unit 123 identifies the distance between the end position of the construction section or the congestion section on the vehicle S side, included in the section information received by the receiving unit 121, and the position of the vehicle S included in the road information received by the receiving unit 121. On the basis of the vehicle speed of the vehicle S and the identified distance, the estimation unit 123 calculates the time to arrival for the vehicle S to reach that end position. The estimation unit 123 estimates that the vehicle S will accelerate when the calculated time to arrival is equal to or greater than the predetermined time period, and estimates that the vehicle S will not accelerate when the calculated time to arrival is less than the predetermined time period.

In other words, the estimation unit 123 estimates that the vehicle S will accelerate when the time to arrival for the vehicle to reach the end position of the construction section or the congestion section on the vehicle S side, based on the distance between that end position and the position of the vehicle S and the vehicle speed of the vehicle S, is equal to or greater than the predetermined time period. On the other hand, when the time to arrival is less than the predetermined time period, the estimation unit 123 estimates that the vehicle S will not accelerate.

The power control unit 124 causes at least one of the battery 4 and the fuel cell 5 to output electric power. As illustrated in FIG. 2, as a result of the estimation unit 123 having estimated that the vehicle S will not accelerate, the power control unit 124 causes the battery 4 to output the first electric power to the mounted equipment 7, and causes the fuel cell 5 to output the second electric power to the motor 6.

On the other hand, as a result of the estimation unit 123 having estimated that the vehicle S will accelerate, the power control unit 124 causes the fuel cell 5 included in the vehicle S to output the predetermined electric power before the vehicle S begins to accelerate. The predetermined electric power is electric power that is greater than the electric power obtained by adding together the first electric power and the second electric power, and is determined by the power control unit 124 on the basis of the type of gradient ahead of the vehicle S. For example, when the type of gradient included in the gradient information is an upward gradient, the power control unit 124 increases the predetermined electric power as compared with the case where the type of gradient is a downward gradient. Then, as illustrated in FIG. 3, the power control unit 124 causes the battery 4 to be charged with surplus electric power obtained by subtracting the first electric power and the second electric power from the predetermined power.

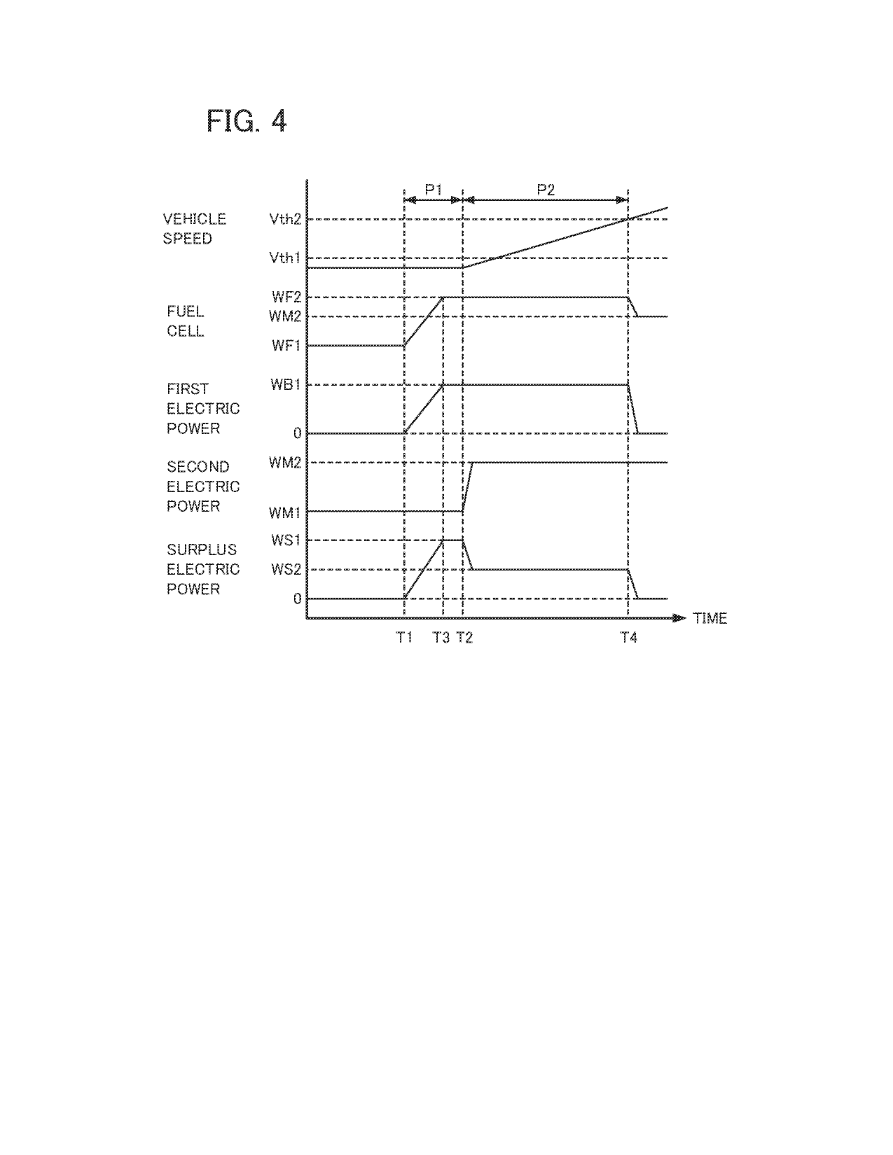

FIG. 4 is a diagram illustrating an example of an operation in which the fuel cell 5 outputs the predetermined electric power. The horizontal axis of FIG. 4 indicates time. In FIG. 4, the vertical axis indicates “vehicle speed” representing the vehicle speed of the vehicle S, “fuel cell” representing the electric power output from the fuel cell 5, “first electric power” supplied from the fuel cell 5 to the mounted equipment 7, “second electric power” supplied from the fuel cell 5 to the motor 6, and “surplus electric power” that is charged into the battery 4. FIG. 4 shows a first threshold value Vth1 and a second threshold value Vth2. In FIG. 4, the state of charge of the battery 4 is less than the predetermined state of charge.

At time T1, as a result of the estimation unit 123 having estimated that the vehicle S will accelerate at time T2, at which a predetermined time period P1 has elapsed, the power control unit 124 starts control for increasing the output of the fuel cell 5 to a predetermined electric power (electric power WF2). Then, at time T3, the power control unit 124 causes the fuel cell 5 to output the electric power WF2. The power control unit 124 causes the fuel cell 5 to output a first electric power WB1, which is a part of the electric power WF2, to the mounted equipment 7, and causes the fuel cell 5 to output a second electric power WM1, which is a part of the electric power WF2, to the motor 6. The power control unit 124 causes the battery 4 to be charged with a surplus electric power WS1 obtained by subtracting the first electric power WB1 and the second electric power WM1 from the electric power WF2.

By operating as described above, the power control unit 124 can maintain the output of the fuel cell 5 at the electric power WF2 even when the vehicle S accelerates as traffic congestion is cleared after the time T2. Furthermore, the power control unit 124 can raise the output of the fuel cell 5 in advance from the time T1, which is a time before the time T2 at which the vehicle S starts acceleration. Therefore, the power control unit 124 can raise the output of the fuel cell 5 after the time T2 over a longer period than the time period required to raise the output of the fuel cell 5 from the electric power WF1 to the electric power WF2 in accordance with the acceleration of the vehicle S. Therefore, since the power control unit 124 can reduce the amount of change in the electric power generated by the fuel cell 5, deterioration of the fuel cell 5 can be suppressed.

For example, after the vehicle S starts acceleration, when the vehicle speed is less than the second threshold value Vth2 and the state of charge is less than the predetermined state of charge, the power control unit 124 continues to output the predetermined electric power (electric power WF2). The second threshold value Vth2 is a speed determined by the power control unit 124 on the basis of the gradient ahead of the vehicle S, at which the power control unit 124 can determine that the vehicle S has passed through the congested section, and is, for example, a value greater than or equal to 14 km per hour and less than 22 km per hour. For example, the power control unit 124 reduces the second threshold value Vth2 when the type of the gradient included in the gradient information is an upward gradient, compared to when the type of the gradient is a downward gradient.

As illustrated in FIG. 4, for example, the power control unit 124 causes the fuel cell 5 to continuously output the electric power WF2 during a time period P2, from the time T2 to time T4. By operating in this manner, even if a driver of the vehicle S increases a depression amount of the accelerator pedal because the traffic congestion clears, the power control unit 124 can output the electric power WF2 including a second electric power WM2 corresponding to the depression amount to the fuel cell 5 in the time period P2. As a result, since the power control unit 124 can maintain the output of the fuel cell 5 at a constant value in the time period P2, deterioration of the fuel cell 5 can be suppressed.

For example, after the vehicle S starts acceleration, and while the power control unit 124 causes the fuel cell 5 to output the predetermined electric power (electric power WF2), the power control unit 124 causes the fuel cell 5 to output the second electric power when the vehicle speed reaches the second threshold value Vth2 or when the state of charge reaches the predetermined state of charge. As illustrated in FIG. 4, for example, when the vehicle speed reaches the second threshold value Vth2 at time T4, the power control unit 124 causes the fuel cell 5 to output the second electric power WM2 corresponding to the depression amount of the accelerator pedal from time T4 onward. By operating in this manner, the battery 4 and the fuel cell 5, at a time after the traffic congestion clears, can output electric power in the same way as at a time before the time when the traffic congestion occurred.

### <Processing sequence in power control apparatus 10>

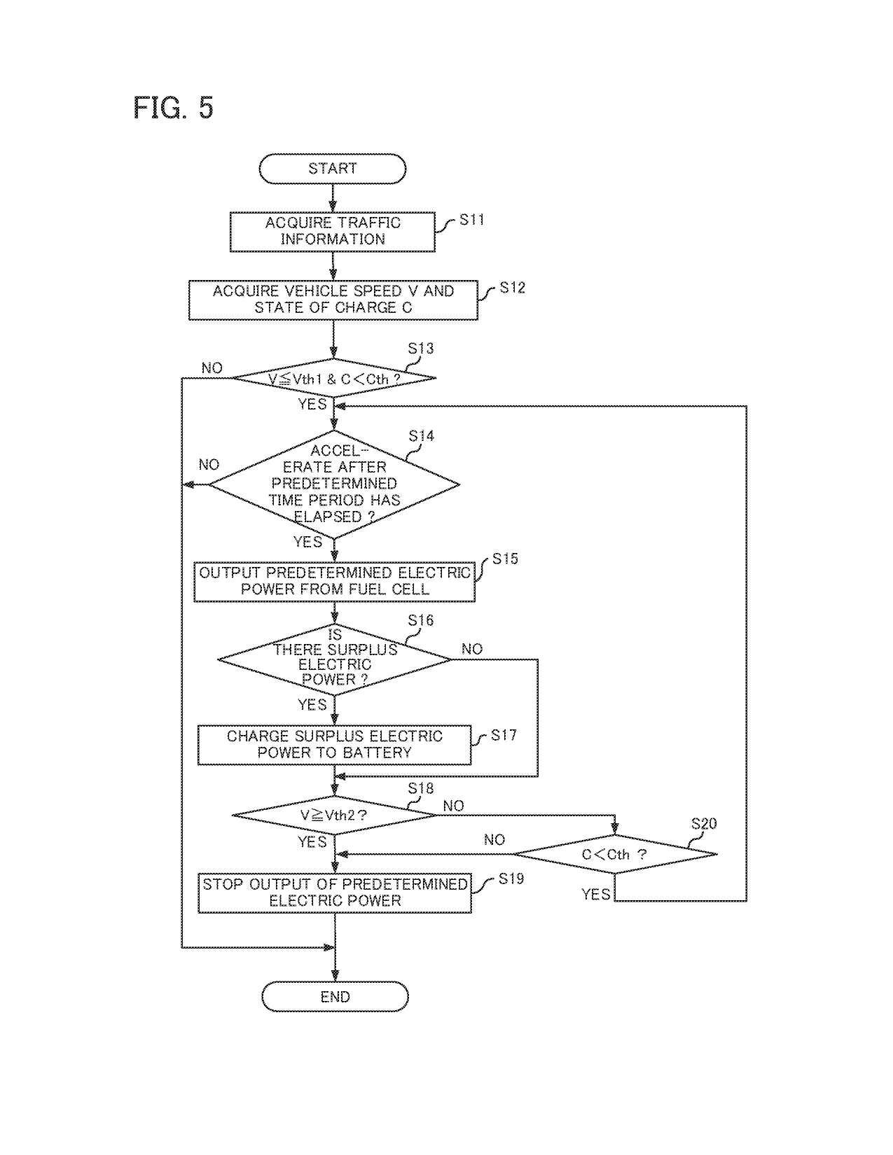

FIG. 5 is a diagram illustrating an example of a processing sequence in the power control apparatus 10. The processing sequence shown in FIG. 5 shows an operation of determining whether the power control apparatus 10 causes the fuel cell 5 to output a predetermined electric power WF2. The power control apparatus 10 repeats the processing sequence shown in FIG. 5 at a predetermined cycle (for example, 0.1 seconds).

The receiving unit 121 acquires traffic information including gradient information, other vehicle information, section information, and road information from the receiving apparatus 1 (S11). The acquisition unit 122 acquires the vehicle speed V of the vehicle S from the vehicle speed sensor 2, and acquires the state of charge C of the battery 4 from the battery sensor 3 (S12). If the vehicle speed V is equal to or less than the first threshold value Vth1 and the state of charge C is not less than a predetermined state of charge Cth (NO in S13), the estimation unit 123 ends the process. If the vehicle speed V is equal to or less than the first threshold value Vth1 and the state of charge C is less than the predetermined state of charge Cth (YES in S13), the estimation unit 123 estimates whether the vehicle S will accelerate after a predetermined time period has elapsed (S14).

If the estimation unit 123 estimates that the vehicle S will not accelerate after the predetermined time period has elapsed (NO in S14), the power control unit 124 ends the process. If the estimation unit 123 estimates that the vehicle S will accelerate after the predetermined time period has elapsed (YES in S14), the power control unit 124 causes the fuel cell 5 to output the predetermined electric power WF2 (S15).

The power control unit 124 causes the fuel cell 5 to output the first electric power of the predetermined electric power WF2 to the mounted equipment 7, and causes the fuel cell 5 to output the second electric power of the predetermined electric power WF2 to the motor 6. If there is surplus electric power obtained by subtracting the first electric power and the second electric power from the predetermined electric power WF2 (YES in S16), the power control unit 124 causes the battery 4 to be charged with the surplus electric power (S17). If there is no surplus electric power obtained by subtracting the first electric power and the second electric power from the predetermined electric power WF2 (NO in S16), the power control unit 124 does not cause the battery 4 to be charged.

If the vehicle speed V of the vehicle S acquired by the acquisition unit 122 after step S15 is equal to or greater than a second threshold value Vth2 (YES in S18), the power control unit 124 stops the output of the predetermined electric power WF2 (S19) and ends the process. If the vehicle speed V is less than the second threshold value Vth2 (NO in S18), the power control unit 124 determines whether the state of charge C acquired by the acquisition unit 122 in step S18 is less than the predetermined state of charge Cth (S20). If the state of charge C is equal to or greater than the predetermined state of charge Cth (NO in S20), the power control unit 124 stops the output of the predetermined electric power WF2 (S19) and ends the process. If the state of charge C is less than the predetermined state of charge Cth (YES in S20), the power control unit 124 returns to step S14.

### <Effects of the power control unit 10>

As described above, the power control apparatus 10 includes: the receiving unit 121 that receives traffic information indicating traffic conditions ahead of the vehicle S; the acquisition unit 122 that acquires the vehicle speed V of the vehicle S and the state of charge C of the battery 4 included in the vehicle S; the estimation unit 123 that estimates whether the vehicle S will accelerate after a predetermined time period has elapsed on the basis of traffic conditions when the vehicle speed V is equal to or less than the first threshold value Vth1 and the state of charge C is less than the predetermined state of charge Cth; and the power control unit 124 that causes, as a result of the estimation unit 123 having estimated that the vehicle S will accelerate, the fuel cell 5 included in the vehicle S to output the predetermined electric power WF2 before the vehicle S begins to accelerate. The power control unit 124 causes the battery 4 to be charged with surplus electric power obtained by subtracting, from the predetermined electric power WF2, the first electric power required by the mounted equipment 7 included in the vehicle S and the second electric power required by the motor 6 included in the vehicle S.

By configuring the power control apparatus 10 in this manner, the power control apparatus 10 causes the fuel cell 5 to output the predetermined electric power WF2 starting from a time before the vehicle S begins accelerating, enabling the electric power generated by the fuel cell 5 to remain constant even when the acceleration of the vehicle S increases. Furthermore, since the power control apparatus 10 causes the fuel cell 5 to output the predetermined electric power WF2 from the time before the vehicle S begins accelerating, it is possible to extend the time period required to raise the electric power output by the fuel cell 5. Accordingly, the power control apparatus 10 can raise the output of the fuel cell 5 with a smaller amount of change than when the electric power is raised as the vehicle S accelerates. As a result, by reducing the amount of change per unit time in the electric power generated by the fuel cell 5, the power control apparatus 10 can suppress deterioration of the fuel cell 5.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A power control apparatus comprising:
a receiving unit that receives traffic information indicating traffic conditions ahead of a vehicle;
an acquisition unit that acquires a vehicle speed of the vehicle and a state of charge of a battery included in the vehicle;
an estimation unit that estimates whether the vehicle will accelerate after a predetermined time period has elapsed on the basis of the traffic conditions in a case where the vehicle speed is equal to or less than a first threshold value and the state of charge is less than a predetermined state of charge; and
a power control unit that causes, as a result of the estimation unit having estimated that the vehicle will accelerate, a fuel cell included in the vehicle to output a predetermined electric power before the vehicle begins to accelerate, wherein the power control unit causes the battery to be charged with surplus electric power obtained by subtracting, from the predetermined electric power, a first electric power required by mounted equipment included in the vehicle and a second electric power required by a drive source included in the vehicle.

2. The power control apparatus according to claim 1, wherein the power control unit, after the vehicle starts acceleration, continues to output the predetermined power when the vehicle speed is less than a second threshold value and the state of charge is less than the predetermined state of charge.

3. The power control apparatus according to claim 2, wherein the power control unit, after the vehicle starts acceleration, and while the power control unit causes the fuel cell to output the predetermined power, causes the fuel cell to output the second electric power when the vehicle speed reaches the second threshold value or the state of charge reaches the predetermined state of charge.

4. The power control apparatus according to claim 2, wherein the traffic information includes gradient information indicating a gradient ahead of the vehicle, and
the power control unit reduces the second threshold value when the gradient is an upward gradient, compared to when the gradient is a downward gradient.

5. The power control apparatus according to claim 1, wherein the traffic information includes other vehicle information indicating a speed of another vehicle ahead of the vehicle, and
the estimation unit estimates whether the vehicle accelerates on the basis of the speed of the other vehicle.

6. The power control apparatus according to claim 5, wherein the estimation unit estimates that the vehicle will accelerate when the time to arrival, based on a distance between a position of the other vehicle and a position of the vehicle and on the vehicle speed of the vehicle, for the vehicle to reach the position of the other vehicle is equal to or greater than the predetermined time period, and estimates that the vehicle will not accelerate when the time to arrival is less than the predetermined time period.

7. The power control apparatus according to claim 1, wherein the traffic information includes section information indicating a construction section or a congestion section ahead of the vehicle, and the estimation unit estimates whether the vehicle will accelerate on the basis of a distance between an end position of the construction section or the congestion section on the vehicle side and the position of the vehicle, and on the vehicle speed.

8. The power control apparatus according to claim 7, wherein the estimation unit estimates that the vehicle will accelerate when a time to arrival for the vehicle to reach the end position, based on a distance between the end position and the position of the vehicle and the vehicle speed of the vehicle, is equal to or greater than the predetermined time period, and estimates that the vehicle will not accelerate when the time to arrival is less than the predetermined time period.

9. The power control apparatus according to claim 1, wherein the estimation unit reduces the predetermined time period when a road on which the vehicle is traveling is a general road, compared to when the road is an expressway.

10. The power control apparatus according to claim 1, wherein the traffic information includes gradient information indicating a gradient ahead of the vehicle, and
the estimation unit reduces the first threshold value when the gradient is an upward gradient, compared to when gradient is a downward gradient.

11. A power control method executed by a processor and comprising:
acquiring a vehicle speed of a vehicle and a state of charge of a battery included in the vehicle;
receiving traffic information indicating traffic conditions ahead of the vehicle;
estimating whether the vehicle will accelerate after a predetermined time period has elapsed on the basis of the traffic conditions in a case where the vehicle speed is equal to or less than a first threshold value and the state of charge is less than a predetermined state of charge;
power-controlling, as a result of estimating in the estimating that the vehicle will accelerate, to cause a fuel cell included in the vehicle to output a predetermined electric power before the vehicle begins to accelerate, the power-controlling including causing the battery to be charged with surplus electric power obtained by subtracting, from the predetermined electric power, a first electric power required by mounted equipment included in the vehicle and a second electric power required by a drive source included in the vehicle.
